(19) United States
(12) Patent Application Publication
(10) Pub. No.: US 2026/0326817 A1
(43) Pub. Date: Oct. 22, 2026

(54) METHODS AND APPARATUS FOR OPERATING A STEER-BY-WIRE STEERING SYSTEM FOR A MOTOR VEHICLE AND STEER-BY-WIRE STEERING SYSTEM

(71) Applicant: Ford Global Technologies, LLC, Dearborn, MI (US)

(72) Inventors: Alexander Ein Waldt, Köln (DE); Sergio Codonesu, Aachen (DE); Oliver Nehls, Düsseldorf (DE); Gerhard Friederich, Bornheim (DE)

(21) Appl. No.: 19/559,383

(22) Filed: Mar. 6, 2026

(30) Foreign Application Priority Data
Apr. 22, 2025 (DE) 102025115407.4

(51) Int. Cl. B62D 6/00

(52) U.S. Cl. CPC B62D 6/002

(57) ABSTRACT

Methods and apparatus for operating a steer-by-wire steering system for a motor vehicle and steer-by-wire steering system are disclosed. A disclosed apparatus for controlling a steer-by-wire steering system of a vehicle includes interface circuitry communicatively coupled to a sensor, machine readable instructions, and at least one programmable circuitry to determine an occurrence of an impact event of the vehicle based on output from the sensor, provide a first wheel alignment signal to a road wheel actuator of the vehicle based on whether the impact event has begun, the first wheel alignment signal corresponding to a first output torque of the road wheel actuator, and provide a second wheel alignment signal to the road wheel actuator if a duration until the impact event is less than a threshold time, the second wheel alignment signal corresponding to a second output torque of the road wheel actuator that is less than the first output torque.

### RELATED APPLICATION

This patent claims priority from DE Patent Application Number 102025115407.4, which was filed on Apr. 22, 2025, and is hereby incorporated herein by reference in its entirety.

### FIELD OF THE DISCLOSURE

The disclosure relates in general to a method for operating a steer-by-wire steering system for a motor vehicle and to a steer-by-wire steering system.

### BACKGROUND

Steer-by-wire (SBW) steering systems are a steering technology, in which the direct mechanical connection between the steering wheel and the vehicle wheel is dispensed with. This direct connection is replaced by two actuators: a steering wheel actuator having feedback which generates a feedback torque for the driver on the steering wheel, and a road wheel actuator, which regulates the at least one, but typically multiple steerable vehicle wheels into the desired position. The feedback torque conveys a feeling about the lateral guidance of the motor vehicle to the driver.

### SUMMARY

An example A disclosed apparatus for controlling a steer-by-wire steering system of a vehicle includes interface circuitry communicatively coupled to a sensor, machine readable instructions, and at least one programmable circuitry to determine an occurrence of an impact event of the vehicle based on output from the sensor, provide a first wheel alignment signal to a road wheel actuator of the vehicle based on whether the impact event has begun, the first wheel alignment signal corresponding to a first output torque of the road wheel actuator, and provide a second wheel alignment signal to the road wheel actuator if a duration until the impact event is less than a threshold time, the second wheel alignment signal corresponding to a second output torque of the road wheel actuator that is less than the first output torque.

An example non-transitory machine readable storage medium includes instructions to cause programmable circuitry to at least determine an occurrence of an impact event of a vehicle based on output from a sensor, provide a first wheel alignment signal to a road wheel actuator of a steer-by wire steering system of the vehicle based on whether the impact event has begun, the first wheel alignment signal corresponding to a first output torque of the road wheel actuator, and provide a second wheel alignment signal to the road wheel actuator if a duration until the impact event is less than a threshold time, the second wheel alignment signal corresponding to a second output torque of the road wheel actuator that is less than the first output torque.

An example method includes determining an occurrence of an impact event of a vehicle based on output from a sensor, providing a first wheel alignment signal to a road wheel actuator of a steer-by wire steering system of the vehicle based on whether the impact event has begun, the first wheel alignment signal corresponding to a first output torque of the road wheel actuator, and providing a second wheel alignment signal to the road wheel actuator if a duration until the impact event is less than a threshold time, the second wheel alignment signal corresponding to a second output torque of the road wheel actuator that is less than the first output torque.

### BRIEF DESCRIPTION OF THE DRAWINGS

The disclosure and further advantageous examples and developments of the same are explained and described in more detail below with reference to the examples illustrated in the drawings. In the figures:

FIG. 1 shows a simplified schematic representation of a motor vehicle having an SBW steering system according to examples disclosed herein.

FIG. 2 shows a simplified schematic representation of an example method for operating an SBW steering system according to examples disclosed herein.

FIG. 3 shows a simplified example schematic representation of a motor vehicle according to examples disclosed herein.

FIGS. 4A to 4C show simplified schematic representations of a steering wheel of an example SBW steering system in accordance with teachings of this disclosure.

FIG. 5 is a block diagram of an example programmable circuitry platform structured to execute and/or instantiate the example machine-readable instructions and/or the example operations of FIG. 2 to implement examples disclosed herein.

The description detailed below in combination with the attached drawings in which the same numbers refer to the same elements is intended to be a description of different examples of the disclosed subject matter and is not intended to constitute the only examples. Each example described in this disclosure serves only as an example or illustration and should not be interpreted as preferred or advantageous with respect to other examples. The illustrative examples contained herein do not make any claim to completeness and do not limit the claimed subject matter to the exact disclosed forms. Various modifications to the described examples are readily apparent to the person skilled in the art, and the general principles defined herein can be applied to other examples and applications without departing from the spirit and scope of the described examples. The described examples are therefore not limited to the shown examples but rather have the largest possible scope of application compatible with the features and principles disclosed here.

In general, the same reference numbers will be used throughout the drawing(s) and accompanying written description to refer to the same or like parts. The figures are not necessarily to scale.

### DETAILED DESCRIPTION

In motor vehicles, in case of an impact event, for example, a momentum event, which accompanies the coming together of the motor vehicle and another object or road user, an airbag that is arranged in the steering wheel of the motor vehicle or behind a cover thereof can be triggered. Such airbags have tailor-made shapes and internal volumes to ensure an improved contour for the head and/or the body of the driver. The shape and internal volumes of the airbags often do not correspond to a rotationally-symmetrical shape in this case.

In a similar manner, modern motor vehicles are constructed and designed such that an improved force absorption of an external force on the vehicle depends on an orientation of the steerable vehicle wheels of the motor vehicle. If the orientation deviates from the zero position (straight-ahead alignment), in general sideways lateral velocity changes are caused on the motor vehicle in case of an external force action, by which a complex force distribution is caused, for example, with respect to the passengers. This can also have the result that airbags, although they are correctly oriented and inflated, can be suboptimally matched to the driver for the respective impact event due to the diverging road wheel orientations, since the additional lateral velocity changes can result in relative displacements.

JP 4296896 B2 discloses an SBW steering system, in which a regulating device ascertains whether a vehicle and an object collide with one another. When an upcoming impact event is ascertained, the regulating device outputs a positioning signal to a steering wheel actuator so that it rotates the steering wheel into a predetermined unfolding position. As soon as the steering wheel is rotated into the unfolding position, the regulating device initiates electric locking of the steering wheel position. The regulating device then triggers the unfolding of a steering wheel airbag.

EP 2 923 918 B1 discloses an SBW steering system comprising a regulating device which is configured to cause a rotation of the steering wheel from a steering position into an impact event position with unchanged steering angle of the vehicle wheels, in which a steering wheel airbag is aligned in relation to the driver position.

U.S. Pat. No. 8,948,442 B2 discloses a motor vehicle comprising a regulating device configured to ascertain an upcoming impact event.

There is therefore a desire to eliminate or at least reduce the disadvantages of known motor vehicles.

The object is achieved by examples disclosed herein. Advantageous configurations are specified herein. Some features are explained with regard to methods, others with regard to SBW steering systems. The corresponding aspects can be correspondingly reciprocally transferred, however.

Some examples of the disclosure relate to a method for operating a steer-by-wire steering system (hereinafter SBW steering system) for a motor vehicle. The SBW steering system comprises at least one road wheel actuator, a steerable vehicle wheel at least indirectly coupled with the road wheel actuator, and a regulating device coupled with the road wheel actuator. The method comprises at least the following steps:
An occurring impact event of the motor vehicle is ascertained by the regulating device or detected by a sensor coupled thereto.
A first wheel alignment signal is output by the regulating device to the road wheel actuator if the impact event has already begun. Based on the first wheel alignment signal, a maximum output torque, which can be output by the road wheel actuator and acts in an impact event position of the at least one steerable vehicle wheel, is requested for a first pre-definable time interval.
A second wheel alignment signal is output by the regulating device to the road wheel actuator if a duration until the occurring impact event is less than a second pre-definable time interval. Based on the second wheel alignment signal, an output torque, which acts from the road wheel actuator on at least one steerable vehicle wheel and is adapted with respect to a steering command (e.g., a desired steering angle, a desired steering position, etc.), is requested.

The example method is based on the finding that current motor vehicles are equipped such that impact events which are already occurring or will also occur in future, such as momentum effects due to the impact between the motor vehicle and an external object, can be detected or ascertained. This has the result that it can be ascertained in particular whether the impact event has already occurred or when the impact event occurs. This can be used to apply a positioning signal, a first or second wheel alignment signal here, to the road wheel actuator so that an output of a torque from the road wheel actuator to align the steerable vehicle wheels of the motor vehicle is caused. It can thus be ascertained in which way the steerable vehicle wheels have to be acted upon, thus with a maximum output torque or with an adapted torque, in which the steering command is taken into consideration. In particular, the steerable vehicle wheels can be guided into an impact event position.

The steerable vehicle wheels can thus be aligned in a defined manner, due to which the introduction of force and force absorption of an external force can be improved. This also has the result that no lateral velocity change is caused with respect to the motor vehicle or its occupants, due to which the relative orientation of a steering wheel of the motor vehicle is improved with respect to the body and/or the head of the driver of the motor vehicle.

In contrast, known approaches only provide an alignment of a corresponding steering wheel of the motor vehicle. However, this does not prevent lateral velocity changes from being caused for the motor vehicle and its passengers due to an oblique position of the steerable vehicle wheels, by which relative position changes can be caused.

Advantageously, no further devices or additional components are required for the implementation of the method for operating an SBW steering system. This means that the method can be implemented and carried out efficiently.

The improved alignment of the steerable vehicle wheels possibly also has the result due to the prevention or reduction of lateral velocity changes that airbags for catching the body or body parts of a passenger of the motor vehicle can be saved or the number of airbags provided at least does not have to be increased. This is based on the fact that relative movements between the driver and the steering wheel along the vehicle transverse axis can be reliably prevented or reduced. Moreover, the method enables enhanced freedom with respect to the design of the steering wheels of the motor vehicles. A large number of advantages is thus made possible.

According to another aspect, some examples disclosed herein relate to an SBW steering system for a motor vehicle. The SBW steering system comprises at least one road wheel actuator, a steerable vehicle wheel at least indirectly coupled with the road wheel actuator, and a regulating device coupled with the road wheel actuator. The regulating device is at least configured to:
ascertain an occurring impact event of the motor vehicle. Alternatively, the regulating device is configured to receive an impact message which indicates the occurring impact event of the motor vehicle, for example, from a sensor,
output a first wheel alignment signal to the road wheel actuator if the impact event has already begun. Based on the first wheel alignment signal, for a first pre-definable time interval, a maximum output torque that can be output by the road wheel actuator and act in an impact event position of the at least one steerable vehicle wheel, can be requested, and
output a second wheel alignment signal to the road wheel actuator if a duration until the occurring impact event is less than a second pre-definable time interval. Based on the second wheel alignment signal, an output torque, which can be output by the road wheel actuator, acts on at least one steerable vehicle wheel, and is adapted with respect to a steering command, can be requested.

The advantages achieved by examples disclosed herein are also correspondingly achieved by the SBW steering system. In particular, the SBW steering system thus can enable requesting the output of an output torque by the road wheel actuator, which can be used to return the vehicle wheels to an impact event position in an improved manner. An alignment of the vehicle wheels which ensures improved introduction of force and force absorption of the external force can thus be induced. As a result, the force action on passengers of the motor vehicle is also improved.

The second wheel alignment signal is such that the output torque output by the road wheel actuator is adapted to the steering command. The output torque output by the road wheel actuator can optionally promote or even force a movement of the steerable vehicle wheels into the impact event position more and more with increasing duration. The second wheel alignment signal in this respect still permits a certain influencing on the basis of the steering command. However, this possibility of influencing is reduced with progressing duration, so that an increasingly larger output torque is requested by the road wheel actuator, which guides the steerable vehicle wheels into an orientation that corresponds to the impact event position.

The road wheel actuator is at least indirectly coupled to a steerable vehicle wheel. The road wheel actuator can optionally also be coupled at least indirectly to multiple steerable vehicle wheels simultaneously, for example, via a toothed rack.

In an alternative, the motor vehicle can also have at least one second road wheel actuator, which can be coupled, for example, to steerable rear wheels of the motor vehicle, for example, via an additional toothed rack.

The multiple road wheel actuators can be jointly regulated by the regulating device.

Each road wheel actuator comprises an electric motor to apply a torque to change the orientation of the steerable vehicle wheels. As an example, the road wheel actuator can apply the torque to the toothed rack in order to be able to set the toothed rack position as needed. The electric motor can comprise, for example, a winding set having three windings, thus a three-phase winding set. Alternatively, the electric motor can also comprise more winding sets.

The impact event can be understood as a momentum event, in which the relevant motor vehicle encounters another object, road user, or the like. In particular, impact events can be momentum events such that a sufficiently high momentum energy is adopted for them that inflation of an airbag is triggered due to the momentum event. In other words, smaller momentum events, which do not cause a significant force action on the motor vehicle, can be neglected in the scope of the method. The regulating device can be configured in this context to estimate a momentum energy for the impact event. For example, for this purpose the regulating device can ascertain a relative velocity between the motor vehicle and the external object or road user in relation to which the occurring impact event is detected.

With regard to the occurring impact event, it is ascertained by the regulating device at a detection time (time of the ascertainment that an impact event has occurred or will occur) that an impact event in the past in relation to the event time (time of the impact event) has already begun or that it is to be presumed that an impact event will occur within the second pre-definable time interval in relation to the event time. In a corresponding manner, the impact message indicates the expected time of the impact event and/or whether the occurring impact event is within the second predefined time interval.

The first predefined time interval represents a presumed duration which is still available in relation to the second pre-definable time interval, which is still usable to advantageously align the steerable vehicle wheels to, thus, advantageously form the introduction of force.

The wheel alignment signal can be understood as a positioning signal that the regulating device outputs to the road wheel actuator to cause the road wheel actuator to output an output torque to a component by an electric motor such that an alignment of at least one steerable vehicle wheel in the direction of the impact event position is caused. The steerable vehicle wheel can thus be pivoted back to the impact event position.

The impact event position can be advantageous for the introduction of force and/or for restraint systems and thus reduces the effects of the force action on the users of the vehicle.

As used herein, the impact event position corresponds to a straight-ahead position, and particularly an orientation of the steerable vehicle wheels such that they are aligned parallel to the longitudinal extension direction of the motor vehicle.

If the steerable vehicle wheel is already arranged in the impact event position before the wheel alignment signal is output by the regulating device, the wheel alignment signal can, thus, nonetheless be output to the road wheel actuator. This has the result that the road wheel actuator nonetheless exerts the output torque on the steerable vehicle wheel in spite of the impact event position of the at least one steerable vehicle wheel, by which a deflection of the steerable vehicle wheel away from the impact event position is obstructed. The configuration of the motor vehicle having a steerable vehicle wheel, which is already aligned in accordance with the impact event position, can thus be made more robust with respect to steering commands, steering actions, and/or external forces.

The maximum output torque caused by the wheel alignment signal is to be understood as the output torque that can be output at most by the electric motor of the road wheel actuator. The output torque output by the electric motor of the road wheel actuator does not have to act directly on the steerable vehicle wheel of the motor vehicle. For example, the output torque output by the electric motor of the road wheel actuator can also be exerted on a component coupled with the steerable vehicle wheel, which ultimately causes the orientation change of the steerable vehicle wheel. For example, the road wheel actuator can be coupled with a toothed rack of the SBW steering system, which, upon deflection from a reference position, for example, a center position, causes a deflection of one or more steerable vehicle wheels out of a reference position, a center position here.

In some examples, the first predefined time interval can be predefined as constant or can be modifiable by a user input and/or a producer input.

Preferably, in some examples, the first predefined time interval can have a duration Δt1, which can in particular be 50 milliseconds (ms), specifically dimensioned from the detected detection time tD; Δt1=t1−tD=50 ms, wherein t1 indicates the end time of the first predefined time interval. This means that the output of the first wheel alignment signal takes place in particular for time intervals tD=0 ms≤x≤t1=50 ms, thus with [tD; t1]=50 ms, wherein x indicates the time from which the maximum torque is actually requested by the road wheel actuator, or the first wheel alignment signal is output to the road wheel actuator. Since the regulating device can necessitate a certain time span to also output the first wheel alignment signal, the detection time tD is in the past relative to the time x. In this constellation, the impact event has already begun. This means that the event time tE is also in the past. The time span between tE and tD corresponds to the duration that the regulating device requires to ascertain that an impact event has occurred. The time span between tD and x corresponds to the time interval that the regulating device requires to trigger the output of the first wheel alignment signal. Since the impact event has already begun, the maximum output torque of the road wheel actuator is requested to induce an improved alignment of the steerable vehicle wheels, independently of a steering command. The first wheel alignment signal is output here for the remaining time interval of [x; t1]. How long the remaining time interval is can depend on the duration that the regulating device requires to trigger the output of the first wheel alignment signal.

In an alternative example configuration, an impact event expected in future is ascertained by the regulating device at the time tD. In this case, only those impact events are ascertained which will occur within the second pre-definable (future) time interval. The lengthened duration of the predictively ascertained impact event can be used to trigger alternative reaction measures, at least for the period of time of the second time interval. In particular, the second pre-definable time interval can be used to trigger a different second wheel alignment signal, which causes different following measures in comparison to the first wheel alignment signal. The second wheel alignment signal is in particular used here such that an adapted output torque for orienting the steerable vehicle wheels is requested by the road wheel actuator. The orientation of the steerable vehicle wheels is adapted corresponding to a steering command. This means that the output torque provided by the road wheel actuator to vary the orientation of the steerable vehicle wheels in particular does not have to be such that the steerable vehicle wheels are necessarily guided in the direction of an impact event position. This is enabled in that the second time interval is longer than the first time interval, specifically dimensioned from the detection time tD of the impact event expected at the (future) event time tE. The second time interval can, therefore, also be sufficiently long that a return of the steerable vehicle wheels to the impact event position is not yet necessary. Therefore, the second time interval can be at least partially used to adapt the orientation of the steerable vehicle wheels on the basis of the steering command such that the occurring impact event is possibly still preventable or can at least be less intensive.

According to examples disclosed herein, the steering command can preferably be based on a steering wheel position of a steering wheel of the SBW steering system. In an alternative example, the steering command can also be produced by a higher-order driving regulation device, which exerts an autonomous or semi-autonomous driving functionality. In the final effect, the steering command describes a specification for the lateral guidance of the motor vehicle.

The second pre-definable time interval can preferably be Δt2=250 ms, thus Δt2=250 ms, dimensioned from the detection time tD of the future impact event occurring at the event time tE. In this respect, it describes a duration which is in the moderate future, thus tD<tE<t2 with [tD; t2]=250 ms, wherein t2 indicates the end time of the second pre-definable time interval.

The second predefined time interval can comprise the first predefined time interval. In this case, the second predefined time interval can extend beyond the time of the impact event. If the second predefined time interval comprises the first predefined time interval, the second predefined time interval results as: Δt2=[tE−200 ms; tE+50 ms]. Therefore, it still always has a total length which is greater than the length of the first time interval, for example, a length of 250 ms. The partial interval tE=0 to tE+50 ms corresponds in this case to the first predefined time interval.

The second wheel alignment signal is triggered, depending on the speed of the regulating device, within the time interval [tD; t2] at the time x, with x>tD. For the remaining duration [x; t2], the second wheel alignment signal is output.

In both configurations, the detection time tD is selected as the reference time, for example. In an alternative example, another reference time can also be selected, for example, the event time tE.

In some examples, the second pre-definable time interval can comprise the first predefined time interval. This means that the second wheel alignment signal can also comprise the first wheel alignment signal. In other words, the second wheel alignment signal can be designed such that for the last partial duration of the second pre-definable time interval, which corresponds to the first predefined time interval, the maximum output torque output by the road wheel actuator is requested to guide the steerable road wheels into the impact event position.

In some examples, the road wheel actuator outputs, based on the received first wheel alignment signal, the maximum output torque acting in the impact event position of the at least one steerable vehicle wheel for the first predefined time interval or a remaining duration thereof. The output torque is output such that the steerable vehicle wheels are guided back in the direction of the impact event position.

The road wheel actuator preferably outputs, based on the received second wheel alignment signal, the output torque, which acts on at least one steerable vehicle wheel and is adapted with respect to the steering command, for the second pre-definable time interval Δt2 with [tD; t2]=250 ms or a remaining duration thereof. In this case, the output torque is output by the road wheel actuator such that the orientation of the steerable vehicle wheels is varied in the direction of the steering command.

Accordingly, the durations of the first and/or second pre-definable time interval can be adapted as needed, for example, matched to the application or the steering system.

The SBW steering system optionally comprises at least one steering wheel actuator coupled to the regulating device. The example method furthermore comprises at least the following step:
Outputting a steering wheel positioning signal by way of the regulating device to the steering wheel actuator if the impact event has already begun or if a duration until the occurring impact event is less than the second pre-definable time interval. Based on the steering wheel positioning signal, a positioning torque, which can be output by the steering wheel actuator and acts in a middle alignment of a steering wheel coupled to the steering wheel actuator, is requested.

It can thus be ensured that the steering wheel can be guided into the middle alignment so that an airbag, which is inflated as a result, is aligned with respect to the body and/or the head of the driver.

The positioning torque is preferably greater than the feedback torque output in the normal operating mode of the SBW steering system at the steering wheel. The steering wheel can thus be aligned in accordance with the method and can only be overcome with difficulty, if at all, by the driver.

The steering wheel actuator is configured to apply a feedback torque and the positioning torque to the steering wheel at least indirectly, for example, via a steering column coupled to the steering wheel. The feedback torque caused by the steering wheel actuator is also used here to give the driver torque feedback about the vehicle lateral guidance. The positioning torque is used to align the steering wheel corresponding to the method.

In general, the steering wheel actuator comprises an electric motor to apply the feedback torque and the positioning torque to the steering wheel. The electric motor can comprise, for example, a winding set having three windings, thus a three-phase winding set. Alternatively, the electric motor can also comprise more winding sets.

Optionally, the SBW steering system can comprise at least one steering wheel sensor that is configured to detect a steering wheel angle, thus a steering wheel position, of the steering wheel and transmit it to the regulating device. The regulating device can thus ascertain the way in which the steering wheel positioning signal is to be output to the steering wheel actuator so that a positioning torque is caused such that the steering wheel is guided in the direction of the middle alignment.

Preferably, based on the steering wheel positioning signal, a maximum positioning torque, which can be output by the steering wheel actuator and acts in a middle alignment of a steering wheel coupled with the steering wheel actuator, is requested if the impact event has already begun. Since the impact event has already begun in this case, the steering wheel is therefore to be guided particularly quickly into the middle alignment. The steering wheel positioning signal is therefore in this case such that the maximum positioning torque that can be output is requested by the steering wheel actuator.

In some examples, the steering wheel actuator outputs a positioning torque acting on the steering wheel based on the received steering wheel positioning signal. For example, the positioning torque can be output such that the steering wheel is rotated in the direction of the middle alignment. The actual return of the steering wheel in the direction of the middle alignment is thus enabled.

The steering wheel positioning signal can be such that the steering wheel actuator outputs the maximum positioning torque that can be output by the steering wheel actuator in this case, due to which the return of the steering wheel to the middle alignment takes place particularly quickly.

In some examples, based on the steering wheel positioning signal, a positioning torque output by the steering wheel actuator is requested in the direction of the smallest angle difference between the actual steering wheel angle and the middle alignment. The middle alignment of the steering wheel is in particular not necessarily to be understood here as the zero position (straight-ahead position) of the steering wheel. A steering wheel can typically be rotated starting from the straight-ahead position more than once counterclockwise or clockwise, thus ±360°. In this respect, the positioning torque output by the steering wheel actuator can in particular act on the steering wheel such that the steering wheel, starting from its present alignment, the actual steering wheel angle, is guided into the closest possible position of a middle alignment, thus the straight-ahead alignment ±360°. The positioning torque is therefore output by the steering wheel actuator such that the angle travel to reach the middle alignment is as short as possible. It makes no difference for the alignment of the airbag whether the steering wheel is pivoted corresponding to its straight-ahead position or corresponding to a complete single revolution (or multiple revolutions) clockwise or counterclockwise.

If the steering wheel has already been pivoted, for example, starting from the straight-ahead position by 300°clockwise, the positioning torque in the present case would not return the steering wheel to the straight-ahead position, but rather would pivot the steering wheel further clockwise until a middle alignment is reached at +360°. As a result, the angle travel to be covered by the steering wheel to reach the middle alignment can be reduced in relation to existing approaches.

In some examples, the method additionally comprises the following step:
Initiating an axial movement of the steering wheel along an axial direction of a steering column coupled to the steering wheel based on the steering wheel positioning signal output by the regulating device.

Some SBW steering systems comprise axial drives, for example, so-called stowage functions, for the axial movement of the steering wheel or parts coupled thereto. In the present case, such an axial drive can be used to cause an axial movement of the steering wheel along the steering column if a (future) occurring impact event is detected or ascertained. In particular, the initiated axial movement can be such that a distance between the steering wheel and a body and/or head of a driver of the motor vehicle is increased as a result of the axial movement. However, this position can also be reduced for specific events, depending on the position of the driver seat and/or the steering wheel, to prevent excessive speed changes and thus achieve a reduction of the effects of the impact event. In other words, this enables improvements of the position longitudinally and vertically in the vehicle to implement the unfolding of the airbag and the occurring speed changes of the driver in a favorable manner via the distance between head/upper body and the airbag.

According to examples disclosed herein, the axial movement is preferably initiated such that it is executable at a speed of at least 40 millimeters (mm)/second(s), more preferably at a speed of at least 45 mm/s. Even in the predefined time intervals mentioned here, for example, the second pre-definable time interval of, for example, only 250 ms, a significant distance increase can thus be enabled between the steering wheel and the body and/or head of the driver of the motor vehicle.

According to examples disclosed herein, the axial movement of the steering wheel along the axial direction of the steering column is only triggered if it is ascertained by the regulating device that the occurring impact event will take place within the second pre-definable time interval, but has not yet already begun. The axial movement of the steering wheel results in a change of the steering wheel position. To ensure stable system states, it can be desirable for the axial movement to only take place if the occurring impact event is still sufficiently far in the future.

In some examples, the example method furthermore comprises the following steps:
Detecting an occurring impact event of the motor vehicle by way of at least one sensor, and
Outputting a detection signal to the regulating device by way of the at least one sensor. The detection signal indicates the detected occurring impact event.

The detection signal here can be such that only those impact events are taken into consideration, of which it is presumed that unfolding an airbag of the motor vehicle will take place. In addition, the detection signal can comprise further information about the occurring impact event, for example, detected trajectories of objects or road users for which the impact event is ascertained.

The sensor is preferably at least one impact event sensor, for example, a speed change sensor, a lidar sensor, a radar sensor, a camera sensor, or an infrared sensor. The sensor is configured to detect an impact event of the motor vehicle with at least one object and to output the corresponding detection signal to the regulating device. While in particular impact event sensors can detect impact events that have already begun, lidar and radar sensors, as well as camera sensors, can be used to detect impact events occurring in future.

The method preferably furthermore comprises at least the following steps:
An event time is ascertained by the at least one sensor based on the detected impact event or by the regulating device based on the received detection signal. The event time indicates a time of the impact event.
The event time is at least compared to a detection time by the regulating device. The detection time indicates the time of the impact event ascertained by the regulating device.

It can, thus, be ascertained when the impact event has occurred or will occur dimensioned from a reference time, namely the detection time tD of the detected impact event. It can be ascertained by the regulating device on the basis of this comparison which measures are to be triggered.

The event time can be ascertained in particular in that the trajectory of the motor vehicle is evaluated with respect to a detected position and/or detected trajectory of the object or road user for which the impact event is ascertained. It can thus be ascertained when the impact event has occurred or will occur, as a result of which the event time can be ascertained. Alternatively, momentum energy effects can be detected to ascertain the event time, which is already in the past, and thus establish that an impact event has already begun.

According to a further aspect, examples disclosed herein also relate to a computer program product comprising commands which, when the program is executed by a computer, cause it to carry out the method as described herein. The advantages achieved by the method described herein are also correspondingly achieved by the computer program product.

According to an additional aspect, the disclosure also relates to a computer-readable storage medium comprising commands, which, when the program is executed by a computer, cause it to carry out the method as described herein. The advantages achieved by the method described herein are also correspondingly achieved by the computer-readable storage medium.

According to a further aspect, some examples of the disclosure relate to a motor vehicle having an SBW steering system as described herein.

The advantages achieved by the SBW steering system described herein are also correspondingly achieved by the motor vehicle.

In the sense of the disclosure, motor vehicles can in particular comprise land vehicles, namely, inter alia, off-road and road vehicles such as passenger vehicles, buses, trucks, and other commercial vehicles. Motor vehicles may be manned or unmanned. The motor vehicles are at least partially electrically driven, thus comprise an electric motor used for the drive. In addition, the motor vehicles can optionally also comprise an internal combustion engine.

All features explained with regard to the various aspects are able to be combined, individually or in (sub)combination, with other aspects.

All features disclosed below with regard to the exemplary examples and/or the accompanying figures can be combined, alone or in any subcombination, with features of the aspects of the present disclosure, including features of preferred examples provided that the resulting combination of features is meaningful to a person skilled in the art in the field of the technology.

For the purposes of the present disclosure, the wording “at least one of A, B and C” means for example (A), (B), (C), (A and B), (A and C), (B and C) or (A, B and C), including all further possible combinations, when more than three elements are listed. In other words, the term “at least one of A and B” generally means “A and/or B”, namely “A” alone, “B” alone or “A and B”.

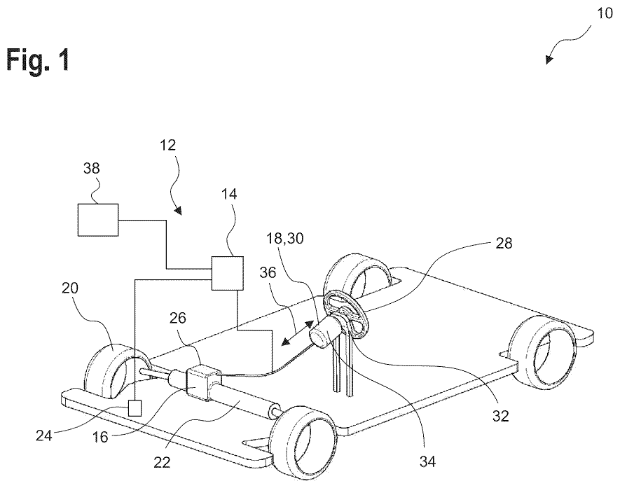

FIG. 1 shows a simplified schematic representation of a motor vehicle 10 having an SBW steering system 12 according to one example.

The SBW steering system 12 comprises a regulating device 14, a road wheel actuator 16, and a steering wheel actuator 18.

The road wheel actuator 16 is indirectly coupled to steerable vehicle wheels 20 of the motor vehicle 10. For this purpose, the road wheel actuator 16 is coupled to a toothed rack 22, which is coupled to the steerable vehicle wheels 20 of the motor vehicle 10. The deflection of the toothed rack 22 results in an orientation change of the steerable vehicle wheels 20.

The motor vehicle 10 additionally comprises at least one sensor 24. The sensor 24 can also be part of the SBW steering system 12. The sensor 24 is an impact event sensor, for example, a speed change sensor, a lidar sensor, a radar sensor, a camera sensor, or an infrared sensor, or a combination thereof. The sensor 24 is configured to detect an impact event, which has already taken place or will occur in future, of the motor vehicle with at least one object and/or road user. Moreover, the sensor 24 is configured to output the corresponding detection signal as a result to the regulating device 14. The detection signal indicates information about the impact event, for example, a position and/or a trajectory of the detected object or road user, for which the impact event is detected.

Furthermore, the SBW steering system 12 comprises a toothed rack sensor 26, which is integral with the road wheel actuator 16 here. The toothed rack sensor 26 is configured to detect a toothed rack position of the toothed rack 22, for example, in relation to a reference position, in particular an impact event position, which corresponds here to an orientation of the steerable vehicle wheels 20 that corresponds to the middle position, thus the straight-ahead alignment. The steerable vehicle wheels 20 are, therefore, then oriented parallel to the longitudinal extension direction of the motor vehicle 10. The toothed rack sensor 26 can therefore be used to ascertain a current orientation of the steerable vehicle wheels 20. The toothed rack sensor 26 transmits the detected toothed rack position of the toothed rack 22, which corresponds with a corresponding orientation of the steerable vehicle wheels 20, to the regulating device 14.

The SBW steering system 12 also comprises a steering wheel 28, to which the steering wheel actuator 18 is at least indirectly coupled, for example, via a steering column. The steering wheel actuator 18 is configured to exert a feedback torque and a positioning torque on the steering wheel 28 so that a feeling about the lateral guidance of the motor vehicle 10 is conveyed to the driver of the motor vehicle 10.

The steering wheel actuator 18 comprises an electric motor. The electric motor of the steering wheel actuator 18 comprises at least one winding set. Each winding set of the electric motor is three-phase and is configured to drive a rotor of the electric motor. As a result, a feedback torque can be provided for the driver by the electric motor on the steering wheel 28 of the motor vehicle 10 to convey a feeling about the lateral guidance of the motor vehicle 10 to the driver or to ensure the lateral guidance autonomously or semi-autonomously. Additionally or alternatively, a positioning torque can be provided by the electric motor to align the steering wheel 28 as needed.

A driver of the motor vehicle 10 can perform steering commands for the motor vehicle 10 by the steering wheel 28.

Additionally, the SBW steering system 12 comprises at least one steering wheel sensor 30 configured to detect a steering wheel angle, thus a steering wheel position, of the steering wheel 28 in relation to a reference position, for example, a middle alignment (zero position). Consequently, the steering wheel sensor 30 can be used to detect steering commands from the driver of the motor vehicle 10 by the steering wheel 28. The steering wheel 28 can be deflected here corresponding to a permissible maximum steering wheel travel 32. The steering wheel travel 32 is typically such that the steering wheel 28, starting from the middle alignment, can be rotated by more than one full revolution clockwise or counterclockwise. Steering wheel travels having fewer than one full revolution are also possible.

According to the illustrated example, the steering wheel sensor 30 is integral with the steering wheel actuator 18. In other examples, however, the steering wheel sensor 30 can also be separate from the steering wheel actuator 18. The steering wheel sensor 30 is configured to transmit the detected steering wheel angle to the regulating device 14.

The regulating device 14 comprises a data processing device. Optionally, in some examples, the regulating device 14, when outputting the wheel alignment signal to the road wheel actuator 16, can take into consideration further parameters of the motor vehicle 10, such as the vehicle speed or speed change values. Of course, these values can also be taken into consideration in the context of the regulation of the feedback torque and/or the positioning torque, which is applied to the steering wheel 28 by the steering wheel actuator 18, thus when outputting the steering wheel positioning signal.

The regulating device 14 outputs a wheel alignment signal to regulate the road wheel actuator 16. Based on the wheel alignment signal, an output torque to be output by the road wheel actuator 16 is requested up to the maximum output torque that can be output by the road wheel actuator 16. The output torque is exerted here by the road wheel actuator 16 on the toothed rack 22, so that a deflection of the steerable vehicle wheels 20 is indirectly changed.

The regulating device 14 outputs a steering wheel positioning signal to regulate the steering wheel actuator 18. Based on the steering wheel positioning signal, a feedback torque and/or a positioning torque to be output by the steering wheel actuator 18 is requested. The steering wheel actuator 18 then outputs the feedback torque and/or the positioning torque, using which the orientation of the steering wheel 28 is at least indirectly changed.

In this example, the SBW steering system moreover comprises a stowage function. The stowage function comprises a drive 34. The drive 34 comprises at least one axial drive and an optional vertical drive for the implementation of the stowage function. The drive 34 is coupled with the steering column of the steering wheel 28. The drive 34 is configured here to ensure an axial displaceability of the steering wheel 28 along the steering column and a vertical displaceability of the steering wheel 28 above the floor. The axial displaceability is represented here by the arrow 36. The drive 34 is also coupled to the regulating device 14. For example, the coupling can also take place via the steering wheel actuator 18. In this respect, the drive 34 can also be part of the steering wheel actuator 18. An axial movement of the steering wheel 28 along the steering column, thus along the arrow 36, and/or a vertical movement of the steering wheel 28 can be initiated by the regulating device 14 based on the steering wheel positioning signal. A distance between the steering wheel 28 and a body and/or head of a driver can, thus, be variably adjusted.

The SBW steering system 12 can also comprise multiple components of the same type and generally the same function, for example, multiple steering wheel sensors 30, by which redundancy is ensured.

In this example, the motor vehicle 10 comprises a higher-order driving regulation device 38 configured to exert autonomous or semi-autonomous driving functionalities. For example, the higher-order driving regulation device 38 can autonomously cause lateral guidance of the motor vehicle 10 in this way. For this purpose, the higher-order driving regulation device 38 can transmit, for example, a steering command to the regulating device 14 of the SBW steering system 12. The steering command corresponds here to a vehicle lateral guidance of the motor vehicle 10 desired by the higher-order driving regulation device 38 corresponding to an exerted driving functionality. This results directly in a change of the orientation of the steerable vehicle wheels 20, since the regulating device 14 transmits a wheel alignment signal to the road wheel actuator 16 based on the steering command.

The example SBW steering system 12 is represented here as front axle steering system. The motor vehicle 10 and the SBW steering system 12 can optionally also comprise further steerable vehicle wheels 20, for example, rear wheels which are coupled to an additional common road wheel actuator 16.

Each road wheel actuator 16 comprises an electric motor. The electric motor comprises at least one winding set, which comprises a group of windings. Each winding set is configured so that phase currents, which can be used to drive a rotor of the electric motor, result in the underlying windings upon the application of supply signals, such as phase voltages. The rotor can then be coupled to a corresponding component of the SBW steering system, for example, the toothed rack 22, and thus enable the movement of the steerable vehicle wheels 20. In general, the electric motor can also comprise more than one winding set.

Each winding set is typically three-phase, so that the electric motor is designed overall as at least three-phase, optionally also six-phase or nine-phase.

If multiple winding sets are present, the winding sets each enable a movement of the rotor of the electric motor independently of other winding sets. This means that the winding sets are separate from one another.

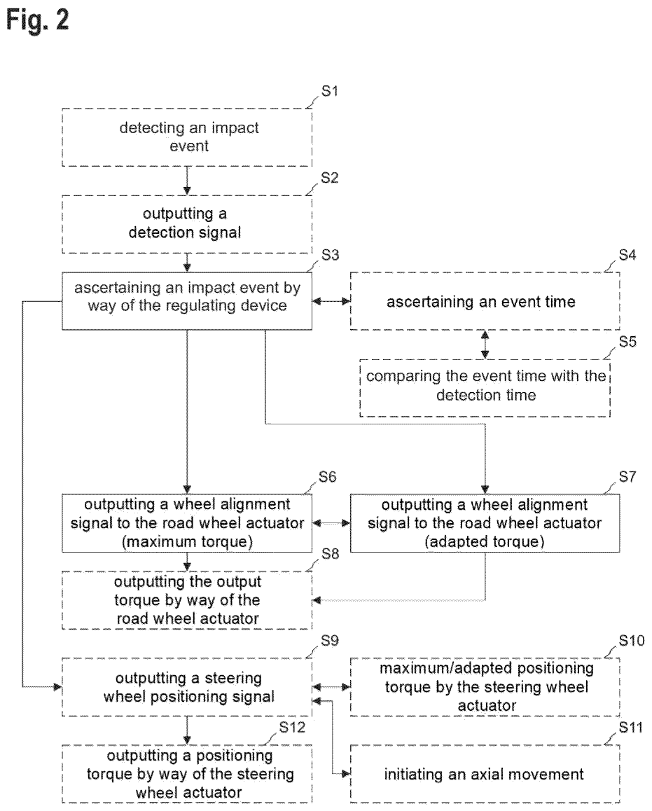

FIG. 2 shows a simplified schematic representation of an example method for operating an SBW steering system in accordance with teachings of this disclosure. Alternative example steps are illustrated by a dashed line.

In optional example step S1, an occurring impact event of the motor vehicle 10 is detected by at least one sensor 24. For this purpose, the sensor 24 can be designed as an impact event sensor, as a radar sensor, or the like. In this respect, the sensor 24 detects an object or a road user in the surroundings of the motor vehicle 10 with respect to its position and/or trajectory. Alternatively, the sensor 24 can be configured to detect an external momentum action on the motor vehicle 10, for example, by an external object or another road user. It can, thus, be ascertained on the basis of the measured values of the sensor 24 that an impact event with the motor vehicle 10 and the object and/or road user has already begun or will occur in future.

Moreover, the sensor 24 can be configured to distinguish objects and/or road users, or to distinguish impact events, as to whether triggering of an airbag of the motor vehicle 10 is to be presumed in the corresponding impact events. For example, the sensor 24 can take into consideration the dimensions of the detected object and/or road user in this case.

In the following optional example step S2, a detection signal is output to the regulating device 14 by the sensor 24. The detection signal can also comprise, for example, information about the position and/or the trajectory of the detected object and/or road user.

According to the following example step S3, an occurring impact event is ascertained by the regulating device 14 at the detection time tD, for example, based on the received detection signal.

In an alternative, the regulating device 14 can also receive an impact message from another component of the motor vehicle 10 that exercises the functionality of ascertaining when an upcoming impact event has occurred or when it will occur. For example, the motor vehicle 10 can comprise a monitoring device which is provided in a dedicated manner for assessing occurring impact events. The impact message, in particular, relates here to those occurring impact events for which it is established that the occurring impact event has already occurred or will occur within the second pre-definable time interval.

According to examples disclosed herein, at optional example step S4, the regulating device 14 ascertains as a refinement of step S3 an event time tE of the impact event which has already begun or is expected in future. The regulating device 14 can again use information which it has received from the sensor 24, for example, by the detection signal. The event time tE can alternatively also be ascertained by the sensor 24 and simply transmitted as part of the detection signal to the regulating device 14. For this purpose, the sensor 24 can be coupled to the regulating device 14 and receive information about the trajectory of the motor vehicle 10. The sensor 24 can then compare this trajectory of the motor vehicle 10 with the position and/or the trajectory of the detected object and/or road user can thus ascertain an event time tE of the occurring impact event.

Optional step S4 can be refined by optional step S5, in which the regulating device 14 compares the event time tE to the detection time tD, which indicates the time of the impact event ascertained by the regulating device 14. The regulating device 14 can thus establish whether the impact event has already occurred (and when) or whether it will occur in future, and if so, whether it will occur within the second pre-definable time interval Δt2.

Proceeding from step S3, the method then comprises steps S6 and S7, depending on whether the occurring impact event has already begun or whether it will occur in future within the second pre-definable time interval.

According to example step S6, the regulating device 14 transmits a first wheel alignment signal to the road wheel actuator 16 if the occurring impact event has already begun. The first wheel alignment signal is such that a maximum output torque 46, which can be output by the road wheel actuator 16 and acts in an impact event position 40 of the at least one steerable vehicle wheel 20, is requested by the regulating device 14 for the first pre-definable time interval Δt1.

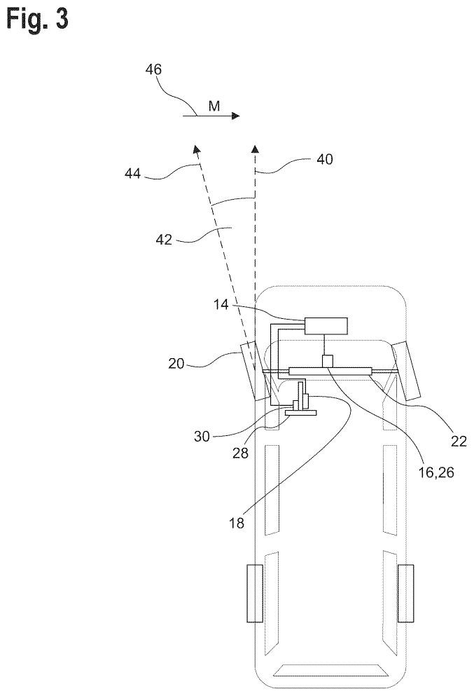

In this context, FIG. 3 shows a simplified schematic representation of a motor vehicle 10 according to one example. It can be seen that the steerable vehicle wheels 20 are deflected in relation to the impact event position 40, which corresponds here to the straight-ahead position of the steerable vehicle wheels 20, by an angle 42 corresponding to a current orientation 44. In other words, the steerable vehicle wheels 20 are pivoted around the vehicle vertical axis. The impact event position 40 is aligned parallel to the longitudinal extension direction of the motor vehicle 10 in a top view. The orientation of the steerable vehicle wheels 20 corresponding to the current orientation 44 is such that the motor vehicle 10 executes cornering.

The first wheel alignment signal which the regulating device 14 outputs to the road wheel actuator 16 is now such that an output torque 46 is requested from the road wheel actuator 16, by which the steerable vehicle wheels 20 are guided back in the direction of the impact event position 40. Since the impact event has already begun in the present case, in particular an output torque 46 is requested from the road wheel actuator 16 such that it is to output the maximum possible output torque 46 for it to return the steerable vehicle wheels 20. The output torque 46 is requested independently of angle from the road wheel actuator 16 by the regulating device 14 in this case. The road wheel actuator 16 is, thus, instructed by the regulating device 14 to output the maximum output torque 46 to move the steerable vehicle wheels 20 into the impact event position 40. The maximum output torque 46 is requested here by the regulating device 14 for a remaining duration of the first predefined time interval, which corresponds to the remaining duration between a time x of the actual output of the first wheel alignment signal and the end time t1 of the first predefined time interval, [x; t1]≤50 ms. How long the remaining duration lasts depends on the regulating speed of the regulating device 14.

In one example, the first wheel alignment signal can also be output for a fixed duration, which corresponds to the first predefined time interval.

In an alternative to example step S6, according to example step S7 of the method, a second wheel alignment signal is output by the regulating device 14 to the road wheel actuator 16 such that an output torque 46 is requested from the road wheel actuator 16 which is adapted to the steering command of the SBW steering system 12. While an output torque 46 is, thus, requested from the road wheel actuator in step S6, by which the steerable vehicle wheels 20 are to be forced to move back in the direction of the impact event position 40, the second wheel alignment signal corresponding to step S7 is different. The second wheel alignment signal is rather such that it corresponds to the steering command of the SBW steering system 12. The steering command can be based here on a steering input of the driver by the steering wheel 28, or can be specified by the higher-order driving regulation device 38, for example, based on an autonomous or semi-autonomous driving functionality. Step S7 thus enables the steering command to be followed, which increases the chance of preventing the impact event or reducing the effects of the impact event.

As a result, the example method may include example step S8, in which the road wheel actuator 16 outputs an output torque 46 based on the respective received wheel alignment signal (first/second wheel alignment signal), which is either maximal and moves the steerable vehicle wheels 20 into the impact event position 40, or is adapted to the steering command. In the latter case, the steerable vehicle wheels 20 do not necessarily have to be moved in the direction of the impact event position 40.

The method may also include optional step S9, in which the regulating device 14 outputs a steering wheel positioning signal to the steering wheel actuator 18, if the regulating device 14 has ascertained an occurring impact event which has already begun or which will occur within the second pre-definable time interval. Based on the steering wheel positioning signal, a positioning torque which can be output by the steering wheel actuator 18 and acts on the steering wheel 28 is requested.

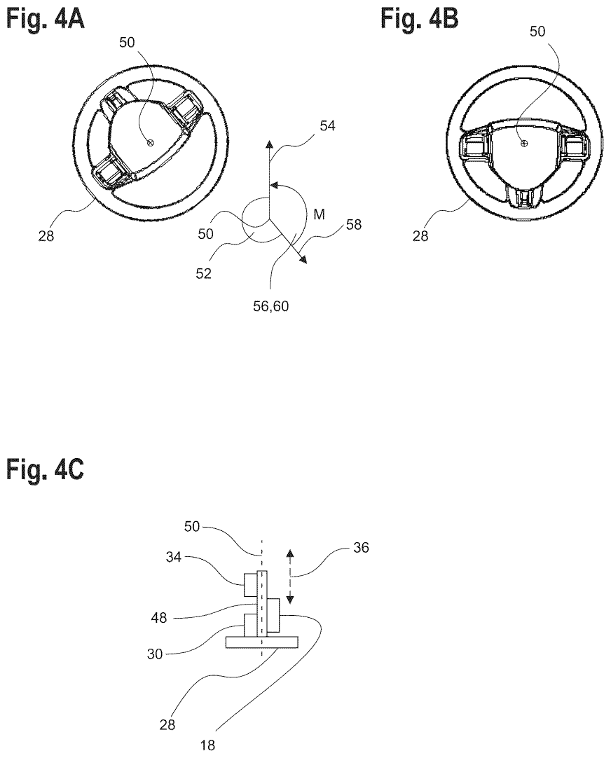

In this context, FIGS. 4A to 4C show simplified example schematic representations of a steering wheel 28 of an SBW steering system 12 according to one example. It can be seen in FIG. 4C that the steering wheel 28 is coupled to a steering column 48. An axis of rotation 50, around which the steering wheel 28 is mounted to be rotatable, is defined by the steering column 48. In addition, a drive 34 is coupled to the steering column 48 according to this example. The drive 34 is configured in this example to be able to move the steering wheel 28 along the steering column 48, as indicated by arrow 36.

The configuration from FIG. 4A shows that the steering wheel 28 is rotated counterclockwise by a steering wheel angle 52. The middle alignment 54 corresponds to a normal alignment (straight-ahead position) of the steering wheel 28, which is shown as an example in FIG. 4B. A steering wheel positioning signal is now output to the steering wheel actuator 18 by the regulating device 14 and a positioning torque 56 to be output on the steering wheel 28 by the steering wheel actuator 18 is requested. The current angular position 58 of the steering wheel 28 is taken into consideration here on the basis of the steering wheel sensor 30. Since the steering wheel 28 in the exemplary configuration of FIG. 4A is already pivoted by more than one half revolution counterclockwise, the steering wheel positioning signal is output by the regulating device 14 to the steering wheel actuator 18 such that a positioning torque 56 is requested from the steering wheel actuator 18 such that the steering wheel 28 is to be rotated further counterclockwise. This is because the resulting angle difference 60, thus the angle travel, between the current angle position 58 of the steering wheel 28 and the middle alignment 54 counterclockwise is shorter than the angle travel which corresponds to a pivot of the steering wheel 28 clockwise in the direction of the zero position of the steering wheel 28.

Optional example step S9 can also be refined by optional example step S10 such that the steering wheel positioning signal is adapted by the regulating device 14 with respect to the intensity of the requested positioning torque 56. If it is established that the occurring impact event has already begun, the steering wheel actuator 18 requests the maximum positioning torque 56 which can be output thereby, and independently of angle, thus independently of the current angular position 58. However, if it is established that the occurring impact event will only occur within the second time interval, an adapted positioning torque 56 can be requested from the steering wheel actuator 18. The adapted positioning torque 56 can be based here, for example, on a current alignment of the steerable vehicle wheels 20 and/or on a current alignment of the toothed rack 22 and/or on a vehicle speed and/or on a vehicle speed change, for example, along the vehicle longitudinal axis or vehicle transverse axis. In the latter case, a positioning torque 56 is thus provided for the driver at the steering wheel 28 such that the positioning torque 56 corresponds to the actual lateral guidance of the motor vehicle 10. However, the positioning torque 56 is generally greater here than the feedback torque provided in the normal operating mode of the SBW steering system 12, so that the driver can only overcome the positioning torque 56 with difficulty.

In a further optional example of the method, the steering wheel positioning signal can also be output by the regulating device 14 according to optional example step S11 such that in addition to the rotation of the steering wheel 28, an axial movement of the steering wheel 28 is initiated along the axial direction of the steering column 48 defined by the axis of rotation 50. For this purpose, the drive 34 can be coupled to the steering wheel actuator 18 or formed as a part thereof. A position change of the steering wheel 28 relative to the body and/or head of a driver of the motor vehicle 10 can thus also be triggered on the basis of the steering wheel positioning signal. The drive 34 can be configured, for example, to move the steering wheel 28 at a minimum speed of 40 mm/s along the axial direction. The axial movement is preferably only initiated when the occurring impact event will occur within the second pre-definable time interval.

According to the following optional example step S12, the steering wheel actuator 18 outputs a positioning torque 56 acting on the steering wheel 28 based on the received steering wheel positioning signal. The positioning torque 56 can correspond here to the maximum positioning torque 56 that can be output by the steering wheel actuator 18 or can be an adapted positioning torque 56, depending on whether the occurring impact event has already begun or will occur within the second time interval.

A method and an SBW steering system 12 are, thus, provided, by which the introduction of force and force absorption of an external force in the motor vehicle 10 can be improved. For this purpose, it is initially established whether an occurring impact event has already begun. If this is the case, steerable vehicle wheels 20 are aligned according to the impact event position, wherein for this purpose the maximum output torque 46 that can be output by the road wheel actuator 16 is used to reduce the time span for aligning the steerable vehicle wheels 20. In addition, the steering wheel 28 can be guided into a middle alignment. If it is established that the occurring impact event will only occur at a later time, the output torque 46 output by the road wheel actuator 16 and the positioning torque 56 output by the steering wheel actuator 18 can be adapted, on the one hand, to guide the motor vehicle 10 corresponding to the steering command and, on the other hand, provide a positioning torque 56 at the steering wheel 28 which corresponds to the actual lateral guidance of the motor vehicle 10 or the position of the vehicle wheels 20 and/or the steering wheel 28 adapted to the impact event. Furthermore, the steering wheel 28 can be changed with respect to its relative position in relation to the body and/or head of the driver of the motor vehicle 10.

Overall, the effects of the occurring impact event can, thus, be reduced for the motor vehicle 10 and its occupants.

Certain examples disclosed herein utilize circuits (e.g. one or more circuits) to implement standards, protocols, methods, or technologies disclosed here, to functionally couple two or more components, to generate information, to process information, to analyze information, to generate signals, to code/decode signals, to convert signals, to transmit and/or to receive signals, to control other devices, etc. Circuits of any kind can be used.

According to examples disclosed herein, a circuit such as the regulating device inter alia comprises one or more data processing devices such as a processor (e.g. a microprocessor), a central processing unit (CPU), a digital signal processor (DSP), an application-specific integrated circuit (ASIC), a field-programmable gate array (FPGA), a system on a chip (SoC) or similar or any combinations thereof and can comprise discrete digital or analog circuit elements or electronics or combinations thereof. In one example, the circuit comprises hardware circuit implementations (e.g. implementations in analog circuits, implementations in digital circuits and the like and combinations thereof).

According to examples disclosed herein, circuits comprise combinations of circuits and computer program products having software or firmware instructions which are stored on one or more computer-readable memories and interact to cause a device to perform one or more of the protocols, methods or technologies described here. In one example, the circuit technology comprises circuits, such as, e.g., microprocessors or parts of microprocessors, which to operate require software, firmware and the like. In one example, the circuits comprise one or more processors or parts thereof and the associated software, firmware, hardware and the like.

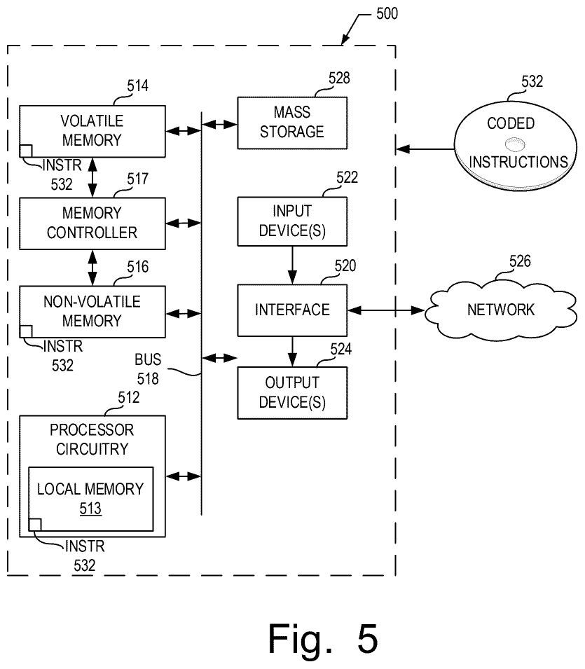

FIG. 5 is a block diagram of an example programmable circuitry platform 500 structured to execute and/or instantiate the example machine-readable instructions and/or the example operations of FIG. 2 to implement examples disclosed herein. The programmable circuitry platform 500 can be, for example, a control device, an electronic control unit (ECU), a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 512 may be implemented by one or more semiconductor based (e.g., silicon based) devices.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a button, a touchscreen, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 532, which may be implemented by the machine-readable instructions of FIG. 2, may be stored in the mass storage device 528, in the volatile memory 514, in the non-volatile memory 516, and/or on at least one non-transitory computer readable storage medium such as a CD or DVD which may be removable.

As used herein, reference can be made to amounts and numbers. Unless explicitly stated otherwise, such amounts and numbers are not to be considered as limiting but rather as examples for the possible amounts or numbers in the context of the disclosure. In this context, the term “plurality” can also be used to refer to an amount or number in the disclosure. In this context, the term “plurality” is meant to mean any number greater than one, e.g. two, three, four, five, etc. The terms “approximately”, “about”, “close to”, etc., mean plus or minus 5% of the stated value.

Although the examples disclosed herein has been described and illustrated with reference to one or more examples, a person skilled in the art, after reading and understanding this description and the attached drawings, will be able to make equivalent changes and modifications.

Example methods, apparatus, systems, and articles of manufacture to enable control of an SBW steering system during an impact event are disclosed herein. Further examples and combinations thereof include the following:

Example 1 includes an apparatus for controlling a steer-by-wire steering system of a vehicle, the apparatus comprising interface circuitry communicatively coupled to a sensor, machine readable instructions, and at least one programmable circuitry to determine an occurrence of an impact event of the vehicle based on output from the sensor, provide a first wheel alignment signal to a road wheel actuator of the vehicle based on whether the impact event has begun, the first wheel alignment signal corresponding to a first output torque of the road wheel actuator, and provide a second wheel alignment signal to the road wheel actuator if a duration until the impact event is less than a threshold time, the second wheel alignment signal corresponding to a second output torque of the road wheel actuator that is less than the first output torque.

Example 2 includes the apparatus as defined in example 1, wherein one or more of the at least one programmable circuitry is to adapt the second wheel alignment signal with respect to a steering command.

Example 3 includes the apparatus of any one or more of examples 1-2, wherein one or more of the at least one programmable circuitry is to output a steering wheel positioning signal to a steering wheel actuator if the impact event has begun or if the duration until the impact event occurs is less than the threshold time, wherein, based on the steering wheel positioning signal, a positioning torque is provided by the steering wheel actuator to act on a steering wheel.

Example 4 includes the apparatus as defined in example 3, wherein, based on the steering wheel positioning signal, a maximum positioning torque provided by the steering wheel actuator operates in a middle alignment range of the steering wheel is requested when the impact event has begun.

Example 5 includes the apparatus as defined in example 4, wherein, based on the steering wheel positioning signal, a positioning torque corresponding to the steering wheel actuator in the direction of the smallest angle difference between the actual steering wheel angle and the middle alignment is requested.

Example 6 includes the apparatus of any one or more of examples 3-5, wherein the steering wheel actuator, based on the received steering wheel positioning signal, outputs a positioning torque acting on the steering wheel.

Example 7 includes the apparatus of any one or more of examples 3-6, wherein one or more of the at least one programmable circuitry is to cause an axial movement of the steering wheel along an axial direction of a steering column coupled to the steering wheel based on the steering wheel positioning signal.

Example 8 includes the apparatus as defined in example 7, wherein the axial movement is initiated at a speed of at least 40 millimeters (mm)/ second(s).

Example 9 includes the apparatus of any one or more of examples 1-8, wherein the first wheel alignment signal corresponds to a maximum output torque corresponding to the road wheel actuator and acts in an impact event position of at least one steerable vehicle wheel, the first wheel alignment signal requested for a pre-definable time interval.

Example 10 includes a non-transitory machine readable storage medium comprising instructions to cause programmable circuitry to at least determine an occurrence of an impact event of a vehicle based on output from a sensor, provide a first wheel alignment signal to a road wheel actuator of a steer-by wire steering system of the vehicle based on whether the impact event has begun, the first wheel alignment signal corresponding to a first output torque of the road wheel actuator, and provide a second wheel alignment signal to the road wheel actuator if a duration until the impact event is less than a threshold time, the second wheel alignment signal corresponding to a second output torque of the road wheel actuator that is less than the first output torque.

Example 11 includes the non-transitory machine readable storage medium as defined in example 10, wherein the instructions cause one or more of the at least one programmable circuitry to adapt the second wheel alignment signal with respect to a steering command.

Example 12 includes the apparatus of any one or more of examples 10-11, wherein the instructions cause one or more of the at least one programmable circuitry to output a steering wheel positioning signal to a steering wheel actuator if the impact event has begun or if the duration until the impact event occurs is less than the threshold time, wherein, based on the steering wheel positioning signal, a positioning torque is provided by the steering wheel actuator to act on a steering wheel.

Example 13 includes the non-transitory machine readable storage medium as defined in example 12, wherein, based on the steering wheel positioning signal, the instructions cause one or more of the at least one programmable circuitry to request a maximum positioning torque of the steering wheel actuator in a middle alignment range of the steering wheel if the impact event has begun.

Example 14 includes the non-transitory machine readable storage medium as defined in example 13, wherein, based on the steering wheel positioning signal, the instructions cause one or more of the at least one programmable circuitry to request a positioning torque corresponding to the steering wheel actuator in the direction of the smallest angle difference between the actual steering wheel angle and the middle alignment.

Example 15 includes the apparatus of any one or more of examples 12-14, wherein the instructions cause one or more of the at least one programmable circuitry to cause an axial movement of the steering wheel along an axial direction of a steering column coupled to the steering wheel based on the steering wheel positioning signal.

Example 16 includes the apparatus of any one or more of examples 10-15, wherein the first wheel alignment signal corresponds to a maximum output torque that is provided by the road wheel actuator and acts in an impact event position of at least one steerable vehicle wheel, the first wheel alignment signal requested for a pre-definable time interval.

Example 17 includes a method comprising determining an occurrence of an impact event of a vehicle based on output from a sensor, providing a first wheel alignment signal to a road wheel actuator of a steer-by wire steering system of the vehicle based on whether the impact event has begun, the first wheel alignment signal corresponding to a first output torque of the road wheel actuator, and providing a second wheel alignment signal to the road wheel actuator if a duration until the impact event is less than a threshold time, the second wheel alignment signal corresponding to a second output torque of the road wheel actuator that is less than the first output torque.

Example 18 includes the method as defined in example 17, including adapt the second wheel alignment signal with respect to a steering command.

Example 19 includes the method of any one or more of examples 17-18, wherein providing the first wheel alignment signal corresponds to requesting a maximum output torque of the road wheel actuator acting in an impact event position of at least one steerable vehicle wheel, the first wheel alignment signal requested for a pre-definable time interval.

Example 20 includes the method of any one or more of examples 17-19, including providing a steering wheel positioning signal to the steering wheel actuator if the impact event has begun or if the duration until the impact event occurs is less than the threshold time, wherein, based on the steering wheel positioning signal, a positioning torque is provided by the steering wheel actuator to act on a steering wheel.

What is claimed is:

1. An apparatus for controlling a steer-by-wire steering system of a vehicle, the apparatus comprising:
interface circuitry communicatively coupled to a sensor;
machine readable instructions; and
at least one programmable circuitry to:
determine an occurrence of an impact event of the vehicle based on output from the sensor;
provide a first wheel alignment signal to a road wheel actuator of the vehicle based on whether the impact event has begun, the first wheel alignment signal corresponding to a first output torque of the road wheel actuator; and
provide a second wheel alignment signal to the road wheel actuator if a duration until the impact event is less than a threshold time, the second wheel alignment signal corresponding to a second output torque of the road wheel actuator that is less than the first output torque.

2. The apparatus as defined in claim 1, wherein one or more of the at least one programmable circuitry is to adapt the second wheel alignment signal with respect to a steering command.

3. The apparatus as defined in claim 1, wherein one or more of the at least one programmable circuitry is to output a steering wheel positioning signal to a steering wheel actuator if the impact event has begun or if the duration until the impact event occurs is less than the threshold time, wherein, based on the steering wheel positioning signal, a positioning torque is provided by the steering wheel actuator to act on a steering wheel.

4. The apparatus as defined in claim 3, wherein, based on the steering wheel positioning signal, a maximum positioning torque provided by the steering wheel actuator operates in a middle alignment range of the steering wheel is requested when the impact event has begun.

5. The apparatus as defined in claim 4, wherein, based on the steering wheel positioning signal, a positioning torque corresponding to the steering wheel actuator in the direction of the smallest angle difference between the actual steering wheel angle and the middle alignment is requested.

6. The apparatus as defined in claim 3, wherein the steering wheel actuator, based on the received steering wheel positioning signal, outputs a positioning torque acting on the steering wheel.

7. The apparatus as defined in claim 3, wherein one or more of the at least one programmable circuitry is to cause an axial movement of the steering wheel along an axial direction of a steering column coupled to the steering wheel based on the steering wheel positioning signal.

8. The apparatus as defined in claim 7, wherein the axial movement is initiated at a speed of at least 40 millimeters (mm)/ second(s).

9. The apparatus as defined in claim 1, wherein the first wheel alignment signal corresponds to a maximum output torque corresponding to the road wheel actuator and acts in an impact event position of at least one steerable vehicle wheel, the first wheel alignment signal requested for a pre-definable time interval.

10. A non-transitory machine readable storage medium comprising instructions to cause programmable circuitry to at least:
determine an occurrence of an impact event of a vehicle based on output from a sensor;
provide a first wheel alignment signal to a road wheel actuator of a steer-by wire steering system of the vehicle based on whether the impact event has begun, the first wheel alignment signal corresponding to a first output torque of the road wheel actuator; and
provide a second wheel alignment signal to the road wheel actuator if a duration until the impact event is less than a threshold time, the second wheel alignment signal corresponding to a second output torque of the road wheel actuator that is less than the first output torque.

11. The non-transitory machine readable storage medium as defined in claim 10, wherein the instructions cause one or more of the at least one programmable circuitry to adapt the second wheel alignment signal with respect to a steering command.

12. The non-transitory machine readable storage medium as defined in claim 10, wherein the instructions cause one or more of the at least one programmable circuitry to output a steering wheel positioning signal to a steering wheel actuator if the impact event has begun or if the duration until the impact event occurs is less than the threshold time, wherein, based on the steering wheel positioning signal, a positioning torque is provided by the steering wheel actuator to act on a steering wheel.

13. The non-transitory machine readable storage medium as defined in claim 12, wherein, based on the steering wheel positioning signal, the instructions cause one or more of the at least one programmable circuitry to request a maximum positioning torque of the steering wheel actuator in a middle alignment range of the steering wheel if the impact event has begun.

14. The non-transitory machine readable storage medium as defined in claim 13, wherein, based on the steering wheel positioning signal, the instructions cause one or more of the at least one programmable circuitry to request a positioning torque corresponding to the steering wheel actuator in the direction of the smallest angle difference between the actual steering wheel angle and the middle alignment.

15. The non-transitory machine readable storage medium as defined in claim 12, wherein the instructions cause one or more of the at least one programmable circuitry to cause an axial movement of the steering wheel along an axial direction of a steering column coupled to the steering wheel based on the steering wheel positioning signal.

16. The non-transitory machine readable storage medium as defined in claim 10, wherein the first wheel alignment signal corresponds to a maximum output torque that is provided by the road wheel actuator and acts in an impact event position of at least one steerable vehicle wheel, the first wheel alignment signal requested for a pre-definable time interval.

17. A method comprising:
determining an occurrence of an impact event of a vehicle based on output from a sensor;
providing a first wheel alignment signal to a road wheel actuator of a steer-by wire steering system of the vehicle based on whether the impact event has begun, the first wheel alignment signal corresponding to a first output torque of the road wheel actuator; and
providing a second wheel alignment signal to the road wheel actuator if a duration until the impact event is less than a threshold time, the second wheel alignment signal corresponding to a second output torque of the road wheel actuator that is less than the first output torque.

18. The method as defined in claim 17, including adapt the second wheel alignment signal with respect to a steering command.

19. The method as defined in claim 17, wherein providing the first wheel alignment signal corresponds to requesting a maximum output torque of the road wheel actuator acting in an impact event position of at least one steerable vehicle wheel, the first wheel alignment signal requested for a pre-definable time interval.

20. The method as defined in claim 17, including providing a steering wheel positioning signal to the steering wheel actuator if the impact event has begun or if the duration until the impact event occurs is less than the threshold time, wherein, based on the steering wheel positioning signal, a positioning torque is provided by the steering wheel actuator to act on a steering wheel.
